(19) United States
(12) Patent Application Publication
(10) Pub. No.: US 2010/0080866 A1
(43) Pub. Date: Apr. 1, 2010

(54) METHOD OF PREPARING DAIRY PRODUCTS CONTAINING NO GLUCIDE

(76) Inventors: Hiroshi Araki, Kakogawa-shi (JP); Yuri Araki, Adachi-ku (JP)

Correspondence Address: SMITH PATENT OFFICE, 1901 PENNSYLVANIA AVENUE N W, SUITE 901, WASHINGTON, DC, 20006, US

(21) Appl. No.: 12/570,782

(22) Filed: Sep. 30, 2009

(30) Foreign Application Priority Data
Sep. 30, 2008 (JP) JP2008/254267

(51) Int. Cl. A23C 9/20; A23C 9/13; A23C 9/137; A23C 9/154

(52) U.S. Cl. 426/43; 426/42; 426/548

(57) ABSTRACT

These dairy products such as ice creams and cream puffs even if made of milk ingredient contain no glucide, preferably with no fat, so that it is an effective dairy products to prevent fatness, high blood sugar level and hypercholesterolemia. The inventive method comprises a step of decomposing milk sugar in the milk ingredient solution and a step of removing monosaccharide came from milk sugar by fermentation. In the fermentation, addition of organic acid can avoid flocculating of monosaccharide with milk protein in order to promote the fermentation.

### BACKGROUND OF THE INVENTION

1. Field of the Invention

This invention is related to method of preparing dairy products containing substantially no glucide or sugar. In this invention, the dairy products mean foods containing a high concentration of milk ingredient such as ice cream and cream puffs.

2. Description of the Related Art

Conventionally, the dairy products such as ice cream and cream puffs are well known to have a good taste because of a high concentration of milk ingredient and important foods because of necessary vitamins and good proteins for human being. However, the dairy products are not classified to diet foods because of a lot of sweet content including milk sugar as well as milk fat at the same time.

As WHO (World Health Organization) points out, obesity is epidemically widely spread in the world of today and causes increases in diabetes and high blood pressure in addition to heart and vascular diseases. From the nineteen-seventies, the United States of America has promoted a low-fat diet having low calories so as to prevent the obesity, and most people have been practiced, but the population having obesity has been rather increased than before and reached up to the present time.

That is, so far, FDA (Food and Drug Administration) has created so-called food pyramid to instruct healthy diets and constructed the pyramid by positioning carbohydrate (60 percents of the entire meals) at the bottom of the pyramid(the most important food), positioning protein there above, and then positioning fat further above, so that the carbohydrate has been mostly emphasized. However, as described above, the population having obesity has been rather increased as the intake of the carbohydrate has been increased and the reduction of caloric value has been progressed. In response to the reversed situations, Dr. Atkins has advocated a low carbohydrate diet for 30 years (reference to Dr. Atkins New Diet Revolution of Robert C. Atkins M. D published by Avon books New York).

Recently, except for Dr. Atkins, the people who support the low carbohydrate diet for example Dr. Agatston the writer of South Beach Diet has been increased, and there was a television debates for diet on May, 2003. Since then, in the United States of America, the people who do not eat bread portion of hamburger, pizza or cookies has been rapidly increased. Also, in Japan, the populations having obesity or diabetes and its estimated groups have been rapidly increased, and there was needs to limit the intake of glucide in particular a refined flour or white rice (reference to The South Beach Diet of Dr. Arthur Agatston M.D. published by Rodale).

### SUMMARY OF THE INVENTION

In order to actively suppress the intake of glucide, and enable people to intake dietary fibers (usually deficient), for preventing an adult disease such as obesity, diabetes, hyperlipemia and high blood pressure, it is proposed to use the wheat bran and rice bran effectively which take most parts among food industrial wastes.

On the other hand, the dairy products are fitted to a healthy program because the milk ingredient contains materials which can control a variety of bodily function. Recently, it is reporter in US that more the intake of dairy products less the possibility to have high blood pressure. It is recommended for Japanese people who take a lot of Na intake to take dairy products for keeping an ideal intake balance between Ca and Na.

Therefore, in order to restrict glucide and fat those ingredient contained even in dairy products become problem, so that those ingredient should be removed therefrom and the skimmed milk has been used for cooking foods. However, elimination of any glucide such as milk sugar in the milk ingredient have not been realized yet although it has been proposed to remove or decompose the glucide and fat in the dairy products.

Recently, glucide in the alcoholic drinks is decomposed by a fermenting treatment to get the resulting products containing no glucide. On the contrary, high concentration aqueous solution of milk ingredient cannot be treated by the alcoholic fermentation because milk sugar is a kind of disaccharide which cannot be used for energy of fermentation. Even though the milk sugar can be decomposed to monosaccharide such as glucose, the monosaccharide in high concentration aqueous solution of milk ingredient is not useful for enzyme fermentation because monosaccharide is too thick in high concentration aqueous solution of milk ingredient and tends to be covered by milk protein. Therefore, from the aspect of the invention, it is a first object to provide a method of preparing dairy products containing no glucide, preferably no glucide and no fat.

After our sharp researches, it is found that under acidic condition, preferably at pH6 or less, the monosaccharide and the milk protein do not tend to flocculate and keep the solubilized state which can promote decomposition of milk sugar and based on the foundation, the present invention was completed. The present invention is to provide a method of preparing dairy products containing substantially no glucide which comprises; subjecting an aqueous solution of high milk ingredient concentration containing more than 10 wt. % of milk ingredient to a hydrolysis process to decompose milk sugar in the milk ingredient aqueous solution into monosaccharide; subjecting the resulting solution containing monosaccharide under acidic condition for avoiding flocculation to a fermentation process to decrease the content of monosaccharide in the aqueous solution up to substantially zero.

In the method of preparing dairy products containing substantially no glucide, it is preferred that the milk ingredient may be made of skimmed milk because the skimmed milk does not contain any fat. In this method, it is preferred that the first hydrolysis process is carried out with glycoside hydrolase such as β-galactosidase family of enzymes which includes lactase involved in the hydrolysis of the disaccharide lactose into constituent galactose and glucose monomers. Further, the second fermentation process is selected from the group consisting of yeast fermentation, alcohol fermentation and yoghurt fermentation. Among them, yeast fermentation is preferred. During the fermentation process, it is preferred that the high concentration milk ingredient aqueous solution under is kept at the acidic condition of pH 6 or less by addition of organic acid selected from the group consisting of lactic acid, citric acid, malic acid and succinic acid, because the acidic condition avoids flocculating and keeps the solubilized state in the high concentration milk ingredient aqueous solution which can promote decomposition of milk sugar.

According to the present invention, even if milk ingredient exists at a high concentration, acidic condition can make it solubilized in the aqueous solution and the fermentation can make monosaccharide coming from the milk sugar consumed as energy of fermentation completely if desired by fermentation enzymes without preventing from monosaccharide such as glucose caught into the protein colloid, there can be provided dairy products containing substantially no glucide, preferably containing substantially no glucide and no fat. Typically, there can be provided an ice cream compound containing substantially no glucide which comprises milk ingredient where milk sugar is decomposed to monosaccharide, which is consumed by the above fermentation, a thickening agent and an artificial sweetening agent. The thickening agent may be selected from the group consisting of dry egg white powder, psyllium seed powder, sodium Alginate, Guar gum Pectin, Glucomannan Arabic gum and Xanthan gum. The artificial sweetening agent may be selected from ones used in the cooking food, which are well known in the food field, not including sugar and the like.

Further, according to another preferred embodiment, there can is provided a cream compound for cream puffs containing substantially no glucide which comprises milk ingredient where milk sugar is decomposed to monosaccharide, which is consumed by the above fermentation, a thickening agent, a coloring agent and an artificial sweetening agent. The thickening agent may be selected from the group consisting of dry egg white powder, psyllium seed powder and xanthan gum and the coloring agent is selected from the group consisting of turmeric and egg yolk.

In this invention, cream compounds do not contain substantially no glucide so that it is preferred corn cup for ice cream and puff shell do not contain no glucide and no fat. Therefore, the corn cup and puff shell had better be prepared from a starting composition comprising bran or soy bean protein as main component added with gluten for binding the main component and milk ingredient processed so as not to contain milk sugar removed by decomposition and yeast fermentation. According to the preferred embodiment, the ice cream containing no glucide and no fat with the corn cup containing no glucide as well as puff shell containing no glucide with cream containing no glucide and no fat can be provided.

According to the present invention, the intake of the glucide and fat can be suppressed even if people eat an ice cream or cream puff as usual, the blood sugar level is kept lower.

As easily understanding the essence of invention from the explanation, the skill in the art can modify the invention without depart from the scope of the claimed invention by using the inventive composition comprising milk sugar removed by decomposition and fermentation.

### DESCRIPTION OF THE PREFERRED EMBODIMENTS

This invention comprises; 1) a step of subjecting an aqueous solution of high milk ingredient concentration containing more than 10 wt. % of milk ingredient to a hydrolysis process to decompose milk sugar in the milk ingredient aqueous solution into monosaccharide;
2) a step of subjecting the resulting solution containing monosaccharide under acidic condition for avoiding flocculation to a fermentation process to decrease the content of monosaccharide in the aqueous solution up to substantially zero.

The starting aqueous solution of milk ingredient may be prepared at a high concentration such as more than 10 wt. % of milk ingredient, preferably by mixing 10 weight portions of skimmed milk added with 30 to 90 weight portion of water, more preferably by mixing 10 weight portions of skimmed milk added with 50 to 70 weight portion of water. Although less than 10 wt. % of milk ingredient can be used, after treatment like dewatering process and so on is necessary and difficult to get a resulting cream-like product.

The first hydrolysis process needs glycoside hydrolase such as β-galactosidase family of enzymes such as lactase which is involved in the hydrolysis of the disaccharide lactose into constituent galactose and glucose monomers. The lactase is used at a mixture rate of more than of 1% based on the milk ingredient. The process is carried out at a temperature of 20 to 40 centigrade and the resulting solution is stirred or left uncontrolled for 2 hours. Considering the amount of milk ingredient and so on, the amount of lactase, the decomposing temperature, the decomposing time can be determined and the finishing time can be detected by the usual glucose reaction.

The fermenting treatment can be selected from the group consisting of yeast fermentation, alcohol fermentation and yoghurt fermentation according to a kind of the resulting products. The milk sugar is decomposed to monosaccharide galactose and glucose which is useful in fermenting as source of energy. In the fermentation, it is necessary to keep the milk ingredient aqueous solution at less than pH 6 by addition of organic acid such as malic acid and so on in order to solubilize the milk ingredient in the solution, which results in avoiding monosaccharide incorporated by milk protein and promoting fermentation by consumption of monosaccharide. After decomposition, the milk ingredient solution is solubilized by commercially available malic acid solution and will be finished after several hours at 30 centigrade by addition of 1 or 2% of yeast based on the milk ingredient solution. After confirmation of glucose content of less than 1%, the resulting solution is heated to 60 to 100 centigrade to deactivate yeast.

### EXAMPLE 1

### Preparation of Ice Cream

The skimmed milk is processed to decompose milk sugar into monosaccharide and mixed with the thickening agent and the artificial sweetening agent to get a ice cream composition. 125 g of skim milk is dissolved into 875 g of water to get 12.5 wt. % of aqueous solution, to which is added 1.25 g of a milk sugar decomposing enzyme made by Godo-shusei Co. Ltd. In Japan. After leaving the resulting solution at 40 centigrade for 2 hours and checking a substantially complete consumption of glucose from the milk sugar, the processed milk gradient solution is added with several drops of malic acid solution having acid degree of 4.5% up to pH 5.4 and also added with 2 to 3 g of yeast powder to be fermented at 30 centigrade with stirring for 3 hours. After deactivating the enzyme, to the resulting solution of 200 ml there are added and mixed 10 g of dry egg white powder, 0.5 g of psyllium powder and appropriate quantities of the artificial sweetening agent. The mixture compound is frozen while stirred to get an ice cream containing substantially no glucide and no fat (glucide and fat residue of less than 1%). In palace of the psyllium powder as the thickening agent, any other thickening agent such as xanthan gum may be used depending on the content of milk protein in the aqueous solution.

### EXAMPLE 2

### Preparation of Cream for Puffs

The skimmed milk is processed to decompose milk sugar into monosaccharide and mixed with the thickening agent and the artificial sweetening agent to get a ice cream composition. 125 g of skim milk is dissolved into 375 g of water to get 25 wt. % of aqueous solution, to which is added 1.25 g of a milk sugar decomposing enzyme made by Godo-shusei Co. Ltd. In Japan. After leaving the resulting solution at 40 centigrade for 2 hours and checking a substantially complete consumption of glucose from the milk sugar, the processed milk gradient solution is added with several drops of malic acid solution having acid degree of 4.5% up to pH 6 and also 2 to 3 g of yeast powder added to 200 ml of the processed milk gradient solution to be fermented at 30 centigrade with stirring for 3 hours. After deactivating the enzyme, to the resulting solution of 200 ml there are added and mixed 20 g of dry egg white powder, 0.5 g of psyllium powder and appropriate quantities of turmeric and the artificial sweetening agent. The mixture compound is frozen while stirred to get an cream compound for spuffsice containing substantially no glucide and no fat (glucide and fat residue of less than 1%). In place of the combination of dry egg white powder and turmeric, whole egg may be used. In palace of or in combination with the psyllium powder as the thickening agent, xanthan gum may be used depending on the content of milk protein in the aqueous solution.

Although the inventive dairy products are eaten as the diet food to suppress the intake of glucide and fat, some addition of fruit juice and fruit flavor is not prohibited and a part of the ice cream compound substituted by the inventive ice cream compound is allowable because it is also a way to save the intake of glucide and fat and a partial alternative use of the inventive dairy compound is also a dieting for preventing diseases associated with adult lifestyle habits.

In order to suppress the intake of glucide and fat according to the present invention, it is recommended to make the corn cup for ice cream and the puff skin according to U.S. patent application Ser. No. 12/073,172, which disclosure is hereby incorporated in this specification by reference. The summary is as follows.

The composition, comprises, as the main components, any one of wheat bran or rice bran, gluten and the molding or thickening agent such as psyllium powder and skim milk processed by lactose degradation and yeast fermentation.

Manufacture 1: Preparation of Puff Skin

600 g of roasted wheat bran and 400 g of gluten powder were mixed and then further mixed with 4 g of psyllium powder to obtain a starting cooking composition.

To 100 weight parts of the starting cooking composition, there are added 3 weight parts of yeast powder, 1 egg/100 g starting cooking composition, 10 weight parts of butter and also a predetermined volume of milk or skim milk water processed by β-galactosidase while adjusting hardness of the resulting dough composition. The resulting wet dough composition was shaped into a proper shape into which the cream composition prepared in Example 2 is added inside and kept at a room temperature for 30 minutes. Then the unit dough is baked at 200 to 210 centigrade for 12 minutes to get a cream puff containing substantially no glucide and sugar.

Manufacture 2: Preparation of Puff Skin

400 g of roasted wheat bran, 100 g of roasted rice bran and 500 g of gluten powder were mixed and then further mixed with 1 g of psyllium powder to obtain a starting cooking composition. To 100 weight parts of the starting cooking composition, there are added 3 weight parts of yeast powder, 1 egg, 10 weight parts of butter and also a predetermined volume of milk or skim milk water processed by β-galactosidase while adjusting hardness of the resulting dough composition. The resulting wet dough composition was shaped into a proper shape into which the cream composition prepared in Example 2 is added inside and kept at a room temperature for 30 minutes. Then the unit dough is baked at about 210 centigrade for 12 minutes to get a cream puff containing substantially no glucide and sugar.

Manufacture 3: Preparation of Corn cup

600 g of roasted wheat bran and 400 g of gluten powder were mixed and then further mixed with 4 g of psyllium powder to obtain a starting cooking composition.

To 100 weight parts of the starting cooking composition, there are added 3 weight parts of yeast powder, 1 egg, 10 weight parts of butter and also a predetermined volume of milk or skim milk water processed by β-galactosidase while adjusting hardness of the resulting dough composition. The resulting wet dough composition was shaped into a proper shape and kept at a room temperature for 30 minutes. Then the unit dough is baked at about 210 centigrade for 12 minutes to get a corn cup containing substantially no glucide and sugar, into which the ice cream composition prepared in Example 1 is added to get a ice cream product containing substantially no glucide and sugar.

Manufacture 4: Preparation of Corn Cup

300 g of roasted wheat bran, 300 g of roasted rice bran and 400 g of gluten powder were mixed and then further mixed with 1 g of psyllium powder to obtain a starting cooking composition. To 100 weight parts of the starting cooking composition, there are added 3 weight parts of yeast powder, 1 egg/100 g starting cooking composition and also a predetermined volume of milk or skim milk water processed by β-galactosidase while adjusting hardness of the resulting dough composition. The resulting wet dough composition was shaped into a proper shape and kept at a room temperature for 30 minutes. Then the unit dough is baked at about 210 centigrade for 12 minutes to get a corn cup containing substantially no glucide and sugar, into which the ice cream composition prepared in Example 1 is added to get a ice cream product containing substantially no glucide and sugar.

As explained above, the inventive dairy products contain no glucide, preferably with no fat, so that it is useful in providing a new cream composition containing a lot of milk ingredient. The new cream compound used for the ice cream and cream puff has no glucide, preferably with no fat, so that it is a good diet dairy products having a good taste which is effective to prevent fatness, high blood sugar level and hypercholesterolemia.

Especially, the inventive dairy products are good for an adult having lactose intolerance.

What is claimed is:

1. A method of preparing dairy products containing substantially no glucide which comprises:
subjecting an aqueous solution of high milk ingredient concentration containing more than 10 wt. % of milk ingredient to a hydrolysis process to decompose milk sugar in the milk ingredient aqueous solution into monosaccharide;
subjecting the resulting solution containing monosaccharide under acidic condition for avoiding flocculation to a fermentation process to decrease the content of monosaccharide in the aqueous solution up to substantially zero.

2. The method of preparing dairy products containing substantially no glucide according to claim 1, wherein the milk ingredient comprises skimmed milk.

3. The method of preparing dairy products containing substantially no glucide according to claim 1, wherein the first hydrolysis process is carried out with glycoside hydrolase such as β-galactosidase family of enzymes including lactase involved in the hydrolysis of the disaccharide lactose into constituent galactose and glucose monomers.

4. The method of preparing dairy products containing substantially no glucide according to claim 1, wherein the fermentation process is selected from the group consisting of yeast fermentation, alcohol fermentation and yoghurt fermentation.

5. The method of preparing dairy products containing substantially no glucide according to claim 1, wherein the fermentation process is carried out in the high concentration milk ingredient aqueous solution under the acidic condition of pH 6 or less by addition of organic acid selected from the group consisting of lactic acid, citric acid, malic acid and succinic acid.

6. Ice cream compound containing substantially no glucide which comprises milk ingredient where milk sugar is decomposed to monosaccharide, which is consumed by a fermentation according to the process claimed in claim 1, a thickening agent and an artificial sweetening agent.

7. Ice cream compound containing substantially no glucide according to claim 1, wherein the thickening agent is selected from the group consisting of dry egg white powder, psyllium seed powder, sodium Alginate, Guar gum Pectin, Glucomannan Arabic gum and Xanthan gum.

8. The ice cream according to claim 6 further comprises, a corn cup comprising any one of wheat bran or rice bran, gluten and the molding agent such as psyllium powder and skim milk processed by lactase decomposition and yeast fermentation.

9. Cream compound for cream puffs containing substantially no glucide which comprises milk ingredient where milk sugar is decomposed to monosaccharide, which is consumed by fermentation according to the process claimed in claim 1, a thickening agent, a coloring agent and an artificial sweetening agent.

10. Cream compound for cream puffs containing substantially no glucide according to claim 1, wherein the thickening agent is selected from the group consisting of dry egg white powder, psyllium seed powder, sodium Alginate, Guar gum Pectin, Glucomannan Arabic gum and Xanthan gum.

11. Cream compound for cream puffs containing substantially no glucide according to claim 1, wherein the coloring agent is selected from the group consisting of turmeric and egg yolk

12. The cream for puffs according to claim 10 further comprises, a corn cup comprising any one of wheat bran or rice bran, gluten and the molding agent such as psyllium powder and skim milk processed by lactase decomposition and yeast fermentation.
